(19) United States
(12) Patent Application Publication
(10) Pub. No.: US 2021/0188001 A1
(43) Pub. Date: Jun. 24, 2021

(54) Sleeve for Wheel

(71) Applicant: Colson Group Holdings,LLC, Oakbrook Terrace, IL (US)

(72) Inventor: Xiong Yan, Nantong City (CN)

(21) Appl. No.: 16/720,405

(22) Filed: Dec. 19, 2019

(51) Int. Cl. B60B 33/00

(52) U.S. Cl. CPC B60B 33/0049; B60B 33/0028; B60B 2310/30; B60B 2900/541; B60B 2380/75; B60B 2900/113

(57) ABSTRACT

A wheel assembly has a wheel with a hub. A rotation surface disposed in the hub has a bore. A sleeve insertable in the bore of the rotation surface has an outer surface with a circumferential groove and first and second opposite axial ends. The first axial end has a shoulder extending radially outward. A resilient ring disposed in the circumferential groove is compressible to a compression diameter sufficient to enable the sleeve to be inserted in the bore of the rotation surface. The resilient ring is expandable to an expansion diameter greater than the inner surface diameter of the bore of the rotation surface when unconstrained. The circumferential groove is spaced from the shoulder at a distance sufficient to enable the resilient ring to expand to the expansion diameter when the sleeve is inserted in the bore of the rotation surface and the shoulder is adjacent the rotation surface.

### BACKGROUND AND SUMMARY

The disclosure is directed to a sleeve for a wheel. More in particular, the disclosure is related to a sleeve for a wheel of a caster that may be removably inserted into a bore of a rotation surface, e.g., an inner race of a bearing, that is disposed in a hub of a wheel. The sleeve has an outer surface with a circumferential groove adapted and configured to receive a resilient ring. The resilient ring is configured to be compressible to allow the sleeve to be inserted into the bore of the rotation surface, e.g., the inner race of the bearing. The resilient ring is configured to be expandable outward when the sleeve is inserted through the bore of rotation surface, e.g., the inner race of the bearing, at distance that clears the effective axial length of the rotation surface. The outward expansion of the ring is greater than an inner diameter of the bore of rotation surface, e.g., the inner race of the bearing, and thus, the sleeve may be retained in the bore of the rotation surface to facilitate assembly of the caster with a yoke and axle pin. The resilient ring is also configured to be sufficiently deformable to allow the sleeve to be removed from the bore of the rotation surface as may be required during assembly of the caster.

### DESCRIPTION OF DRAWINGS

FIG. 1 is a perspective view of an exemplary wheel used in a caster with an exemplary sleeve assembly installed in a hub of the wheel.

FIG. 2 is a perspective view of an exemplary sleeve assembly comprising a sleeve and resilient ring.

FIG. 3 is a cross-sectional view of the sleeve of FIG. 2 taken along a longitudinal axis of the sleeve assembly.

FIG. 4 is a cross-sectional view of the wheel of FIG. 1 taken along an axis of rotation of the wheel.

FIG. 5 is an enlarged view of detail area 5-5 of FIG. 4.

FIG. 6 is an exploded cross-sectional view of the wheel of FIG. 4 showing assembly with an axle pin and yoke of the caster.

### DETAILED DESCRIPTION

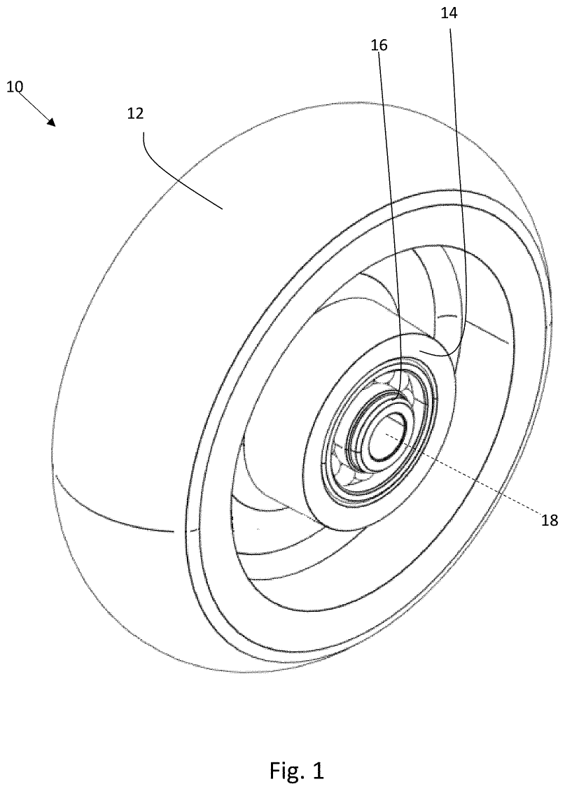

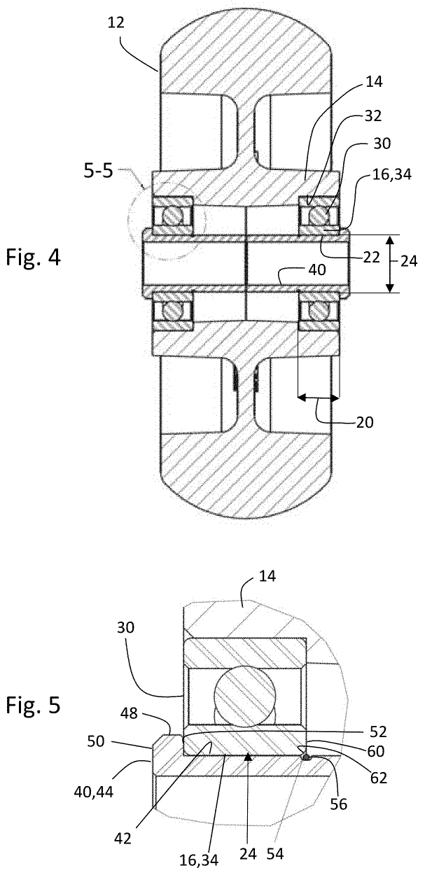

The description that follows refers to a sleeve assembly that is used with a wheel for a caster. The sleeve assembly may be used with other wheels as well. Referring to FIG. 1, the exemplary caster 10 has a wheel 12 with a hub 14. The hub 14 may be monolithically formed with the wheel or may be integral with the wheel for instance, through an overmolding process, a press fit installation, mechanical and/or adhered connection as is known in the art. A rotation surface 16 may be disposed in the hub 14 and configured to allow the wheel 12 to rotate about a rotation axis 18. The rotation surface 16 may define the radially innermost rotation surface of the wheel hub 14. The rotation surface 16 may be a portion of the wheel hub, a bushing, a journal, a sleeve, or an inner race of a bearing disposed in the hub where the bearing has inner and outer races and rotational elements disposed between the inner and outer races. A rotation surface 16 may be provided on one axial end of the hub 14, and a second rotation surface may be provided on the other axial end of the hub. The rotation surface 16 may extend partially through the hub 14. The rotation surface 16 may have an axial length 20 and a bore 22 with an inner surface diameter 24. For instance, as best shown in FIG. 4, a rotary bearing 30 is inset in a recess 32 formed in the side face of the hub 14 with an inner race 34 defining the rotation surface 16 with the inner race having the bore 22 with the inner surface diameter 24 and the axial length 20 extending partially through the hub.

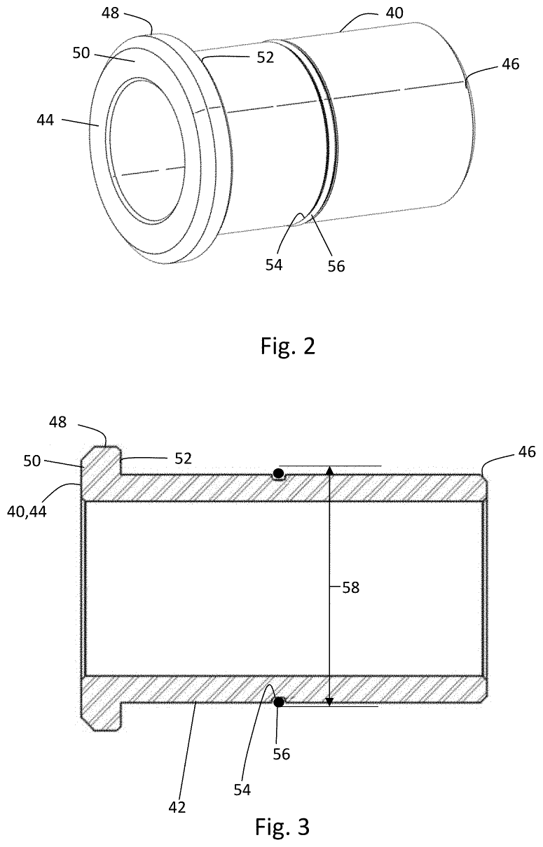

Referring to FIGS. 2 and 3, the caster wheel 12 includes a sleeve 40 that may be insertable in the bore 22 of the rotation surface 16. The sleeve 40 may have an outer surface 42, and first and second opposite axial ends 44,46. The first axial end 44 of the sleeve 40 may have a shoulder 48 extending radially outward from the outer surface 42 of the sleeve. The shoulder 48 may have inner and outer faces 50,52. The sleeve outer surface 42 of the sleeve 40 may have a circumferential groove 54. A resilient ring 56 may be disposed in the circumferential groove 54 of the sleeve outer surface 42. The resilient ring 56 and circumferential groove 54 may be configured and dimensioned to allow the resilient ring to be retained in the circumferential groove while allowing the resilient ring to expand and compress as needed in manner described below. The resilient ring 56 may have an outer diameter 58. The sleeve outer surface 42 may cylindrical and aside from the circumferential groove 54 may be devoid of other surface features. The resilient ring 56 may be an o-ring. The resilient ring 56 may be configured to be compressible in the circumferential groove 54 in a manner such that the resilient ring outer diameter 58 may be compressed to a resilient ring compression diameter sufficient to enable the sleeve 40 to be inserted in the bore 22 of the rotation surface 16. The resilient ring 56 may be configured to be expandable in the circumferential groove 54 such that the resilient ring outer diameter 58 may expand to a resilient ring expansion diameter greater than the inner surface diameter 24 of the bore 22 of the rotation surface 16 when the resilient ring 56 is unconstrained about the resilient ring outer diameter, for instance, when the resilient ring passes through the bore of the rotation surface and clears the effective axial length of the bore of the rotation surface. Referring to FIGS. 4 and 5, the inner face 52 of the shoulder 48 of the sleeve 40 may positioned to abut a face of the rotation surface 16 when inserted in the bore 22 of the rotation surface. Accordingly, the circumferential groove 54 of the sleeve outer surface 42 may be spaced from the shoulder inner face 52 at a distance sufficient to enable the resilient ring outer diameter 58 to expand to the expansion diameter when the sleeve 40 is inserted in the bore 22 of the rotation surface 16 and the shoulder inner face 52 abuts the rotation surface. In another example, a flinger structure or seal disk (not shown) may form the face of the rotation surface 16 and/or otherwise be disposed between the rotation surface and the shoulder inner face 52. In this configuration, the circumferential groove 54 of the sleeve outer surface 42 may be spaced from the inner face 52 of the shoulder 48 at a distance sufficient to enable the resilient ring outer diameter 58 to expand to the expansion diameter when the sleeve is inserted in the bore of the rotation surface and the shoulder inner face is adjacent the rotation surface and abutting the flinger structure or seal disk. In another example, as best shown in FIG. 5, the rotation surface 16 has an axial inner edge with an edge break, and the circumferential groove 54 of the sleeve outer surface 42 is spaced from the inner face 52 of the shoulder 48 at a distance sufficient to enable the resilient ring outer diameter 58 to expand to the expansion diameter adjacent the edge break when the sleeve 40 is inserted in the bore of the rotation surface and the shoulder inner face 52 is adjacent or abuts the rotation surface 16, as the case may be depending upon whether the rotation surface has an intermediate structure. In the last example, the circumferential groove 54 of the sleeve outer surface 42 is spaced from the inner face 52 of the shoulder 48 at a distance sufficient to enable the resilient ring 56 to clear the effective axial length of the rotation surface 16. Where no edge break condition is provided on the innermost axial edge of the rotation surface, the circumferential groove 54 of the sleeve outer surface 42 may be spaced from the inner face 52 of the shoulder 46 at a distance sufficient to enable the resilient ring 56 to clear the axial length of the rotation surface 16 and expand to the expansion diameter. In each of the examples above, the shoulder 48 may be pressed against the face of the rotation surface (or intermediate structure) to provide indication that the resilient ring has cleared the axial length of the rotation surface and has thus expanded to the resilient ring expansion diameter. The sleeve may also be dimensioned to allow some axial play between the shoulder and the face of the rotation surface (or intermediate structure) with the resilient ring cleared from the axial length of the rotation surface and at the resilient ring expansion diameter, for instance, to allow the sleeve to be grasped by the shoulder 48 and extracted from the bore 22 of the rotation surface. The resilient ring 56 may be configured to be sufficiently deformable such that the resilient ring outer diameter 58 may be compressed to an extraction diameter to enable the sleeve to be removed from the bore of the rotation surface the bearing with minimal force, as may be required during the assembly process. Accordingly, the resilient ring 56 may be configured so that the sleeve 40 is removably insertable in the bore of the rotation surface 10. The outer surface of the sleeve may have a close running fit (or with more accuracy a precision running fit) with the bore of the rotation surface thus allowing the sleeve to have a relatively small amount of clearance with the bore of the rotation surface with moderate requirements for accuracy. The outer surface of the sleeve may have a sliding fit (or with more accuracy a close sliding fit) with the bore of the rotation surface thus allowing the sleeve to have a relatively minimal amount of clearance with the bore of the rotation surface with higher requirements for accuracy. The resilient ring may deform to the compression and extraction diameter without otherwise changing the nature of the fit between the sleeve and the bore of the rotation surface.

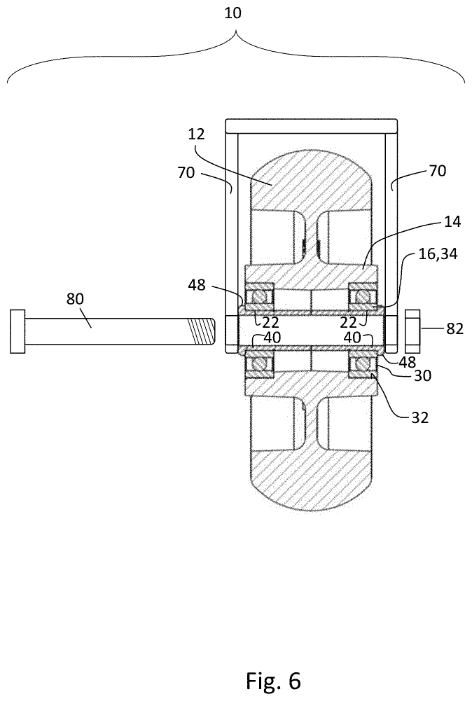

Referring to FIG. 6, with the sleeve 40 installed in the respective bore 22 of the rotation surface 16, the sleeve forms a mounting surface for the rig fork or yoke 70 of the caster 10. In one example where first and second sleeves 40 are inserted in the respective bores 22 of the inner races 34 of the bearings 30 on axial opposite sides of the hub 14 of the wheel, the sleeves may abut against each other inside the hub of the wheel. The caster forks 70 may then be tightened against the sleeves 40 with an axle pin 80 and fastener 82. The caster forks 70 may bear against the shoulders 48 of the respective sleeves 40 which in turn loads the faces of the inner races 34 of the bearings 30. The wheel bearing 30 can then spin freely around the sleeves 40 without binding. Accordingly, each sleeve 40 is adapted and configured to receive an axle pin 80 of the caster to secure the respective fork 70 against the shoulder 48 of the sleeve 40.

In use, the sleeve 40 may be pushed into the bore 22 of the inner race 34 of the bearing 30 disposed in the hub 14 of the wheel 12. As the case may be, a second sleeve may be pushed into the bore of the inner race of a second bearing disposed on an axially opposite side of the hub of the wheel. The sleeve 40 may retained in the bore 22 of the inner race 34 of the bearing 30 by the resilient ring 56, e.g., an o-ring. The resilient ring 56 may be arranged on the sleeve 40 such that its outer diameter 58 compresses to a compression diameter as the sleeve is being inserted into and slides through the bore 22 of the inner race 34 of the bearing 30 disposed in the hub 14 of the wheel 12. The resilient ring 56 may be arranged on the sleeve 40 to return to its full or expansion diameter 58 once the resilient ring 58 passes through the bore 22 of the inner race 34 past the effective axial length of the bore of the inner race of the bearing. The result is that the sleeve 40 “snaps” into place within the bore 22 of the inner race 34 of the bearing 30 and is retained therein. This eliminates the need to use an external device, for instance, a tie or zip tie, to keep the sleeve 40 with the wheel 12 during the manufacturing and assembly process. The expansion of the resilient ring 56 is sufficient to retain the sleeve 40 in the bore 22 of inner race 34 of the bearing 30. However, the resilient ring 56 is sufficiently deformable to allow the resilient ring outer diameter 58 to compress to an extraction diameter to enable the sleeve 40 to be removed from the bore 22 of the inner race 34 of the bearing 30 with minimal force, as may be required during the assembly process.

Further embodiments can be envisioned by one of ordinary skill in the art after reading this disclosure. In other embodiments, combinations or sub-combinations of the above-disclosed invention can be advantageously made. The example arrangements of components are shown for purposes of illustration and it should be understood that combinations, additions, re-arrangements, and the like are contemplated in alternative embodiments of the present invention. Thus, various modifications and changes may be made thereunto without departing from the broader spirit and scope of the invention as set forth in the claims and that the invention is intended to cover all modifications and equivalents within the scope of the following claims.

1. A wheel assembly comprising:
a yoke;
a wheel with a hub;
a rotation surface disposed in the hub, the rotation surface having a bore with an inner surface diameter;
a sleeve insertable in the bore of the rotation surface, the sleeve having an outer surface and an inner surface defined by an inner diameter, the sleeve having first and second opposite axial ends, the first axial end having a shoulder extending radially outward from the outer surface, the sleeve outer surface having a circumferential groove; and
a resilient ring disposed in the circumferential groove of the sleeve outer surface, the resilient ring having an outer diameter, the resilient ring outer diameter being compressible to a compression diameter sufficient to enable the sleeve to be inserted in the bore of the rotation surface, the resilient ring outer diameter being expandable to an expansion diameter greater than the inner surface diameter of the bore of the rotation surface when the resilient ring is unconstrained about the resilient ring outer diameter;
wherein the circumferential groove of the sleeve outer surface is spaced from the shoulder at a distance sufficient to enable the resilient ring to expand to the expansion diameter when the sleeve is inserted in the bore of the rotation surface and the shoulder is adjacent the rotation surface;
wherein the sleeve is adapted and configured to receive an axle pin through the inner diameter of the sleeve; and
wherein the axle pin provides the sole connection of the wheel to the yoke.

2. The wheel assembly of claim 1 wherein the rotation surface comprises an inner race of a bearing.

3. The wheel assembly of claim 1 wherein the sleeve has a close running fit with the bore of the rotation surface.

4. The wheel assembly of claim 1 wherein the sleeve outer surface is cylindrical.

5. The wheel assembly of claim 1 wherein the resilient ring is an o-ring.

6. The wheel assembly of claim 1 wherein the shoulder has an inner face, and the wherein the circumferential groove of the sleeve outer surface is spaced from the shoulder inner face at a distance sufficient to enable the resilient ring outer diameter to expand to the expansion diameter when the sleeve is inserted in the bore of the rotation surface and the shoulder inner face abuts the rotation surface.

7. The wheel assembly of claim 1 wherein the rotation surface has an axial inner edge with an edge break and the circumferential groove of the sleeve outer surface is spaced from the shoulder at a distance sufficient to enable the resilient ring outer diameter to expand to the expansion diameter adjacent the edge break when the sleeve is inserted in the bore of the rotation surface and the shoulder is adjacent the rotation surface.

8. (canceled)

9. (canceled)

10. The wheel assembly of claim 1 wherein the resilient ring outer diameter is compressible to an extraction diameter sufficient to enable the sleeve to be removed from the bore of the rotation surface.

11. A wheel assembly comprising:
a wheel with a hub;
a first bearing disposed in the hub, the first bearing having an inner race with a bore having an inner surface diameter;
a first sleeve insertable in the bore of the inner race of the first bearing, the first sleeve having an outer surface and an inner surface defined by an inner diameter, the first sleeve having first and second opposite axial ends, the first axial end having a shoulder extending radially outward from the outer surface, the first sleeve outer surface having a circumferential groove; and
a first resilient ring disposed in the circumferential groove of the first sleeve outer surface, the first resilient ring having an outer diameter, the first resilient ring outer diameter being compressible to a first resilient ring compression diameter sufficient to enable the first sleeve to be inserted in the bore of the inner race of the first bearing, the first resilient ring outer diameter being expandable to a first resilient ring expansion diameter greater than the inner surface diameter of the bore of the inner race of the first bearing when the first resilient ring is unconstrained about the first resilient ring outer diameter;
a second bearing disposed in the hub axially opposite the first bearing, the second bearing having an inner race with a bore having an inner surface diameter;
a second sleeve insertable in the bore of the inner race of the second bearing, the second sleeve having an outer surface and an inner surface defined by an inner diameter, the second sleeve having first and second opposite axial ends, the first axial end of the second sleeve having a shoulder extending radially outward from the outer surface, the second sleeve outer surface having a circumferential groove; and
a second resilient ring disposed in the circumferential groove of the second sleeve outer surface, the second resilient ring having an outer diameter compressible to a second resilient ring compression diameter sufficient to enable the second sleeve to be inserted in the bore of the inner race of the second bearing, the second resilient ring outer diameter being expandable to an second resilient ring expansion diameter greater than the inner surface diameter of the bore of the inner race of the second bearing when the second resilient ring is unconstrained about the second resilient ring outer diameter;
wherein the circumferential groove of the first sleeve outer surface is spaced from the shoulder at a distance sufficient to enable the first resilient ring to expand to the first resilient ring expansion diameter when the first sleeve is inserted in the bore of the inner race of the first bearing and the shoulder is adjacent the inner race of the first bearing;
wherein the circumferential groove of the second sleeve outer surface is spaced from the shoulder at a distance sufficient to enable the second resilient ring outer diameter to expand to the second resilient ring expansion diameter when the second sleeve is inserted in the bore of the inner race of the second bearing and the shoulder of the second sleeve is adjacent the inner race of the second bearing; and
wherein the first and second sleeves are adapted and configured to receive an axle pin insertable through the respective inner diameters of the first and second of the sleeves.

12. A method comprising:
providing a wheel with a hub with a rotation surface disposed in the hub, wherein the rotation surface has a bore with an inner surface diameter;
providing a sleeve wherein the sleeve has an outer surface and first and second opposite axial ends, wherein the first axial end has a shoulder extending radially outward from the outer surface, and wherein the sleeve outer surface has a circumferential groove;
providing a resilient ring disposed in the circumferential groove of the sleeve outer surface, wherein the resilient ring has an outer diameter, wherein the resilient ring is compressible to a resilient ring compression diameter sufficient to enable the sleeve to be inserted in the bore of the rotation surface with the resilient ring disposed in the circumferential groove of the sleeve outer diameter, and wherein the resilient ring is expandable to a resilient ring expansion diameter greater than the inner surface diameter of the bore of the rotation surface when the outer diameter of the resilient ring is unconstrained about the resilient ring outer diameter;
inserting the sleeve in the bore of the rotation surface in a manner such that the resilient ring disposed in the circumferential groove of the sleeve outer surface is positioned relative to the rotation surface to enable the resilient ring to expand to the expansion diameter;
arranging a yoke of a caster at the sleeve shoulder;
inserting an axle pin through the yoke and the sleeve; and
securing the sleeve to the yoke with the axle pin.

13. The method of claim 12 wherein the step of providing the wheel with the hub with the rotation surface disposed in the hub includes providing a bearing with an inner race forming the rotation surface.

14. The method of claim 13 further comprising:
providing a further bearing disposed in the hub axially opposite the bearing, wherein the further bearing has an inner race with a bore having an inner surface diameter;
providing a further sleeve wherein the further sleeve has an outer surface and first and second opposite axial ends, wherein the further sleeve first axial end has a shoulder extending radially outward from the outer surface, wherein the further sleeve outer surface has a circumferential groove; and
providing a further resilient ring disposed in the circumferential groove of the further sleeve outer surface, wherein the further resilient ring has an outer diameter, wherein the further resilient ring is compressible about the further resilient ring outer diameter to a further resilient ring compression diameter sufficient to enable the further sleeve to be inserted in the bore of the inner race of the further bearing with the further resilient ring disposed in the further sleeve outer diameter circumferential groove, wherein the further resilient ring is expandable to a further resilient ring expansion diameter greater than the inner surface diameter of the bore of the inner race of the further bearing when the further resilient ring is unconstrained about the further resilient ring outer diameter; and
inserting the further sleeve in the bore of the inner race of the further bearing in a manner such that the further resilient ring disposed in the circumferential groove of the further sleeve outer surface is positioned relative to the inner race of the further bearing to enable the further resilient ring to expand to the further resilient ring expansion diameter.

15. The method of claim 12 wherein the step of inserting the sleeve in the bore of the rotation surface includes positioning the shoulder adjacent the rotation surface.

16. The method of claim 12 wherein the step of providing the sleeve includes providing the sleeve in manner to have a close running fit with the bore of the rotation surface.

17. The method of claim 12 wherein the step of providing the resilient ring includes providing the resilient ring as an o-ring.

18. The method of claim 12 wherein the step of inserting the sleeve in the bore of the rotation surface includes positioning an inner face of the shoulder against a face of the rotation surface.

19. (canceled)

20. (canceled)
